(19) United States
(12) Patent Application Publication
(10) Pub. No.: US 2007/0105414 A1
(43) Pub. Date: May 10, 2007

(54) Swivellable electric socket-plug combination

(76) Inventor: Ran Kohen, Aventura, FL (US)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/580,451

(22) PCT Filed: Nov. 22, 2004
(86) PCT No.: PCT/US04/39399

§ 371 Date: May 23, 2006

(30) Foreign Application Priority Data
Nov. 24, 2003 (IL) 159032

(51) Int. Cl. H01R 25/00

(52) U.S. Cl. 439/120

(57) ABSTRACT

A flexible socket (10) has a plug (12) revolvable therein for conducting electric power. The plug (12) mechanically supports in a desired orientation an appliance (14) receiving power from the plug (12). A central releasable latching mechanism (16) allows partial or total withdrawal of the plug. Partial withdrawal is used to change the support angle of the appliance (14). Total withdrawal is used to transfer the appliance (14) to another location.

The present invention relates to the support of light electric appliances such as light fittings and small fans.

More particularly, the invention provides an improved plug and socket combination powering and supporting an appliance in a manner allowing the user to readily change its orientation. The combination is particularly useful where there is a frequent need to move appliances from one location to another and for constructors of new buildings.

In a two previous disclosures, Israel Patent no. 126246 and Israel Patent application no. 139261 the present inventors have described a socket and plug combination for conducting electric power and for mechanically supporting a light-weight appliance by means of said plug. Such appliance can be a luminaire, small TV receiver or camera, a small fan or the like. The present specification is a development of and an improvement on the later patent, which is hereby incorporated herein by reference.

Recently published U.S. patents have not furthered the state of the art as far as the subject of the present invention is concerned. Tzeng Jeng has disclosed a swivellable receptacle in no. 6,332,794 B1 which is not intended to carry a mechanical load. The same applies to the plug seen in no. 6,595,782 B1 to Hsiao.

While the socket plug combination according to our previous patent operated well a better embodiment has been developed. Depending on the geometry of the application, there were instances of angular slippage.

Furthermore, it has been found that there are applications where the previously provided three wires, for single-phase power plus earth, were inadequate to service the appliance or appliances the user required.

It is therefore one of the objects of the present invention to obviate the limitations of prior art electrical plugs and sockets and to provide a more reliable and more versatile revolvable plug-socket combination.

The present invention achieves the above objects by providing a combination of a fixable socket and a plug revolvable therein for conducting electric power and for mechanically supporting in a desired orientation an appliance receiving said power, said combination comprising:
a) a socket rigidly attachable to a structure surface, said socket comprising a non-conductive body configured for attachment to said surface, and a front face including at least four spaced-apart hollow arcuate receptacles, all said receptacles having a common center of curvature, each receptacle containing a conductive element insulated from the remaining conductive elements and being electrically connected to its own cable terminal, a first set of radial locator elements being provided on said front face:
b) a plug, insertable into said socket and revolvable therein, said plug comprising a non-conductive body having a rear face configured to carry a second set of locator elements to contact and engage first set of locator element for retention of said plug in a desired angular position relative to said socket, a plurality of arcuate conducting prong elements insulated from each other and engagable with said arcuate receptacles to contact said conductive elements disposed therein, each prong element being electrically connected to its own plug cable terminal, said plug being arranged to mechanically support an appliance which is electrically connected to receive power from said plug cable terminals, and
c) releasable latching means attached to said combination, providing when engaged a retention force between said socket and said plug to retain said locator elements in inter-engagement, said latching means being hand releasable to allow full disengagement of said plug and said appliance attached thereto, and also to allow partial withdrawal for disengagement of said locator elements to permit revolution of said plug while maintaining contact with said socket.

In a preferred embodiment of the present invention there is provided a socket and plug combination, wherein said hollow arcuate receptacles extend through 360 degrees to allow full revolution of said plug in said socket.

In a most preferred embodiment of the present invention there is provided a socket and plug combination wherein said locator elements comprise a series of teeth disposed on a face surrounding the largest of said hollow arcuate receptacles.

Yet further embodiments of the invention will be described hereinafter.

In U.S. Pat. No 6,346,716 to Seo there is described and claimed an adaptor with a rotary plug. The socket to be used is a standard or close to standard multi-outlet wall socket. The two-prong plug is mounted inside an adaptor casing to allow 45 to 90 degrees of revolution, so that the adaptor can be plugged in without fouling adjacent plugs carrying power to other appliances. A small shoulder on the plug prong is to prevent inadvertent release of the plug from the socket. The adaptor supported is not an appliance but a transformer-rectifier intended to supply low voltage DC current to an appliance.

In contradistinction thereto, the present invention relates to a socket and plug which are configured to support the appliance itself. Four electrical connections are provided, and the appliance angle can be adjusted as required, and locked at the desired A 4 wire connection is primarily intended for serving an appliance having two power-consuming units, for example two lights or a light and a small fan, or a light and a camera, where two separate user switches are to be provided for operating either, both or neither of the small appliances. The 4-wire connection can also be used for operating a 3-phase appliance, while retaining the earth wire.

It will thus be realized that the novel device of the present invention serves to provide firm support for appliance which may need to be moved from a first location to a second or further location as desired by the user. For example, a doorway that needs to be monitored may have a light plus a small closed-circuit TV focused on the area which might be used by an intruder. When the camera and light are needed for a second location, they may be de-plugged and re-plugged in a socket at the new location. The user will quickly be able to change the light/camera angle by revolving the plug in its socket as needed.

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

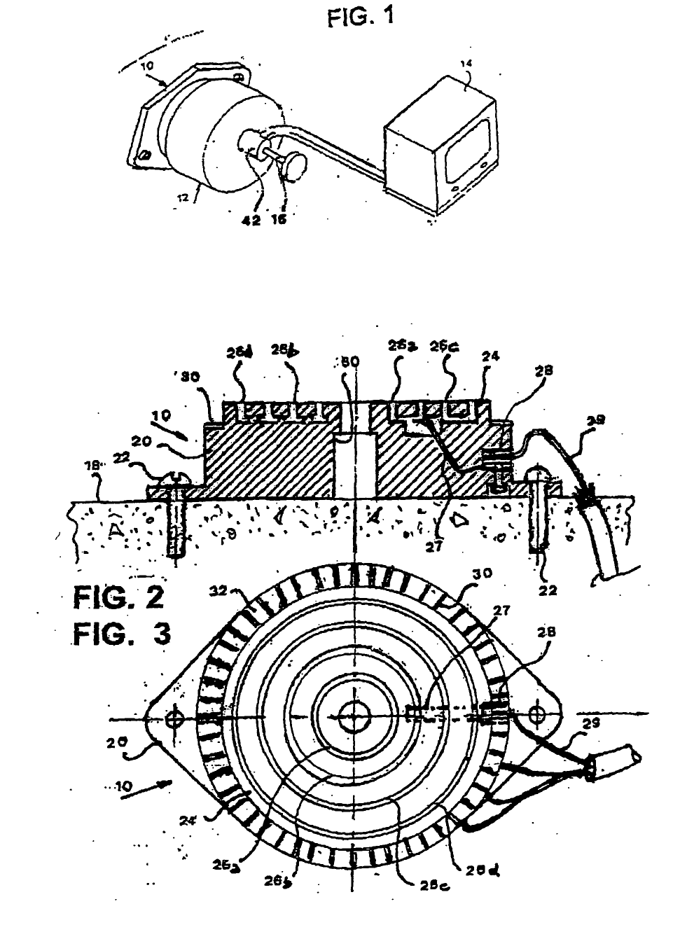

FIG. 1 is a perspective view of a preferred embodiment of the combination according to the invention, wherein the appliance is a closed-circuit TV receiver;

FIG. 2 is a sectional elevational view of the socket;

FIG. 3 is a plan view of the same socket;

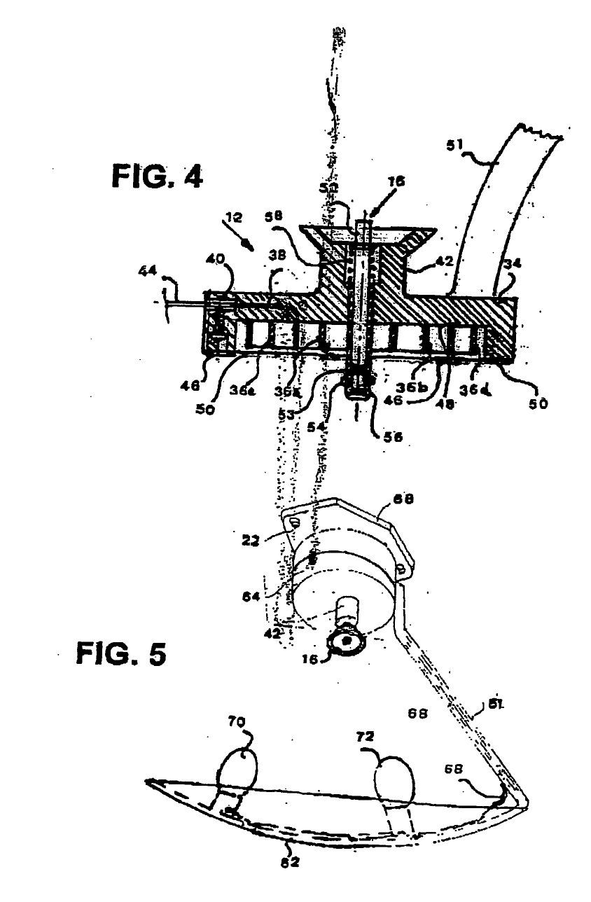

FIG. 4 is a sectional elevational view of the plug and retaining device; and

FIG. 5 is a perspective view of an embodiment carrying two lamps.

There is seen in FIG. 1 a combination of a fixable socket 10 and a plug 12 revolvable therein for conducting electric power. The plug 12 mechanically supports in a desired orientation an appliance 14 receiving power from the plug 12. A central releasable latching mechanism 16 allows partial or total withdrawal of the plug. Partial withdrawal is used to change the support angle of the appliance 14. Total withdrawal is used to transfer the appliance 14 to another location.

FIGS. 2 and 3 show details of the socket 10. The socket is arranged to be rigidly attachable to a structure surface 18, usually a building wall, but possibly to a floor or ceiling. The socket 10 has a non-conductive body 20, suitably made of phenolic resin. The embodiment shown is arranged for attachment by fasteners 22 to surface 18. The body 20 can of course be configured for attachment in a wall recess.

A front face 24 of the socket includes four spaced-apart hollow arcuate receptacles 26a,b,c,d. The receptacles 26 all have a common center of curvature. At the lower portion of each receptacle 26 there is flexible conductive element 27, only one of which is seen in FIG. 2 insulated from the remaining conductive elements 27, each of which is electrically connected to its own cable terminal 28, only one terminal 28 and inserted wire 29 being shown in the figure.

An integrally molded set of first radial locator elements 30 are provided on a front face 32 of the socket 10, the reference being to the outward face of the socket which is seen after the socket is wall attached. Preferably the first locator elements 30 comprise a series of teeth disposed on the face of 32 surrounding the largest of the hollow arcuate receptacles 28d. The largest diameter on face 32 provides excellent retention against plug angular slippage.

A recess 60 is provided in socket 10, its purpose will be explained with reference to FIG. 4.

FIG. 4 illustrates the plug 12, which is sized to be insertable into the socket 10 seen in FIGS. 2 and 3. The plug also has a non-conductive body 34. Four arcuate conducting prong elements 36a,b,c,d electrically insulated from each other are rigidly attached to the plug body 34, and are engagable with the arcuate receptacles 26. In the preferred embodiment of the socket 10 shown in FIG. 3, the receptacles 26 form a complete circle; consequently the plug 12 is revolvable therein through 360 degrees.

Each prong element 36 has a conducting connection 38 leading to its own plug cable terminal 40, seen on a side of the plug body 34. When the plug 12 is inserted into the socket 10, each prong element 36 contacts the flexible conductive element 27 disposed at the lower portion of each socket receptacle 26, seen in FIGS. 2 and 3.

The plug body 34, or the housing 42 of the latching mechanism 16 carried by the plug 12, is arranged to mechanically support, by means of an arm 51, one or two small appliances 14, for example a light and a small TV camera, or two lamps as seen in FIG. 5. The appliance(s) 14 are electrically connected by wires 44 to receive power from the plug cable terminals 40. Due to the provision of three power-carrying terminals 40 (plus an earth terminal) the appliances 14 may be switched on or off independently of each other. The plug body 34 has an inner rear face 48 which carries the arcuate conducting prong elements 36.

A second set of locator elements 46 are carried on an external rear face 50. Only 2-4 second locator elements 46 are needed to provide adequate angular location locking for the plug 12. If desired, however more elements 46 can be provided. The external rear face 50 can contact or come into close proximity to the face 32 of the plug 12 when inserted in the socket 10. The second set of locator elements 46 engages the first set of locator elements 30 seen in FIG. 2 and locks the plug 12 in a desired angular position relative to the socket 10.

It will be noticed that it makes no difference whether the first set of locator elements 30 are on the socket 10 and the second set 46 are on the plug 12 as shown, or whether this order is reversed.

Releasable attaching means 16 are attached to the plug 12. In the normal released mode shown in the figure, the latching means resist unintended disengagement of the plug 12, and in particular maintain the locator elements 30, 46 in inter-engagement. The latching means 16 are hand releasable by finger pressure on the head of a release plunger 52 to allow full disengagement of the plug 12 and the appliance(s) 14 supported by means of arm 51, and also to allow partial withdrawal of the plug 12 for temporary disengagement of the first and second locator elements 30, 46. Partial withdrawal allows revolution of the plug 12 while maintaining electrical contact with the socket 10. In the shown embodiment releasable latching means 16 comprises a captive ball 54 detent, which engages an appropriate recess 60 in the socket 10 seen in FIG. 2. The balls 54 are released to withdraw inwards when downward movement of the plunger 52 allows the balls 54 to enter the plunger recess 53. Following plunger release, a spring 58 returns the plunger 52 to its locking position and the balls 54 are forced to project outwards from the plunger sleeve 56 to lock against the socket recess 60.

Preferably latching means 16 engages the recess 60 with sufficient retention force to support a two kg appliance in a ceiling socket during an earthquake of a severity not causing structural damage to the building in which the combination is installed. Users do not expect plug retention during an earthquake severe enough to cause structural damage to the building.

With regard to FIG. 5, similar reference numerals have been used to identify similar parts.

Seen in FIG. 5 is an embodiment wherein the appliance is an electric light fitting (luminaire) 62 carrying two lamps 70, 72. The luminaire 62 is connected to a 4-core cable 68, wherein two live wires, one neutral and one earth are provided. Consequently each lamp 70, 72 can be independently switched on or off.

The scope of the desired invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

We claim:

1. A combination of a fixable socket and a plug revolvable therein for conducting electric power and for mechanically supporting in a desired orientation an appliance receiving said power, said combination comprising:
a) a socket rigidly attachable to a structure surface, said socket comprising a non-conductive body configured for attachment to said surface, and a front face including at least four spaced-apart hollow arcuate receptacles, all said receptacles having a common center of curvature, each receptacle containing a conductive element insulated from the remaining conductive elements and being electrically connected to its own cable terminal, a first set of radial locator elements being provided on said front face;
b) a plug, insertable into said socket and revolvable therein, said plug comprising a non-conductive body having a rear face configured to carry a second set of locator elements to contact and engage said first set of locator element for retention of said plug in a desired angular position relative to said socket, a plurality of arcuate conducting prong elements insulated from each other and engagable with said arcuate receptacles to contact said conductive elements disposed therein, each prong element being electrically connected to its own plug cable terminal, said plug being arranged to mechanically support an appliance which is electrically connected to receive power from said plug cable terminals, and
c) releasable latching means attached said combination, providing when engaged a retention force between said socket and said plug to retain said locator elements in inter-engagement, said latching means being hand releasable to allow full disengagement of said plug and said appliance attached thereto, and also to allow partial withdrawal for disengagement of said locator elements to permit revolution of said plug while maintaining contact with said socket.

2. The socket and plug combination a claimed in claim 1, wherein said hollow arcuate receptacles extend through 360 degrees to allow full revolution of said plug in said socket.

3. The socket and plug combination as claimed in claim 1, wherein said releasable latching means is a captive ball detent.

4. The socket and plug combination as claimed in claim 2, wherein said locator elements comprise a series of teeth disposed on a face surrounding the largest of said hollow arcuate receptacles.

5. The socket and plug combination a claimed in claim 1, wherein said latching means engages said first structural element with sufficient retention force to support a two kg appliance in a ceiling socket during an earthquake of a severity not causing structural damage to the building in which said combination is installed.

6. The socket and plug combination a claimed in claim 1, wherein said appliance is an electric light fitting.

7. A fixed socket and revolvable plug combination substantially as described hereinbefore and with reference to the accompanying drawings.
